(19) United States
(12) Patent Application Publication
(10) Pub. No.: US 2013/0128687 A1
(43) Pub. Date: May 23, 2013

(54) RAPID RATE CHEMCIAL SOLUTION GENERATOR

(71) Applicant: ARCH CHEMICALS, INC., Norwalk, CT (US)

(72) Inventor: Zachary Harris Adams, Marietta, GA (US)

(73) Assignee: ARCH CHEMICALS, INC., Norwalk, CT (US)

(21) Appl. No.: 13/652,067

(22) Filed: Oct. 15, 2012

Related U.S. Application Data
(60) Provisional application No. 61/547,399, filed on Oct. 14, 2011.

(51) Int. Cl. C02F 1/68; B01F 15/00

(52) U.S. Cl. CPC C02F 1/687; B01F 15/0035
USPC 366/138; 366/151.1; 366/153.1; 366/152.1; 366/182.3; 366/142

(57) ABSTRACT

A rapid rate chemical solution generator system and a method of generating a chemical solution from the system to rapidly treat a body of water. The system and method are especially useful in emergency situations. The system includes a tank for mixing chemical material with water, a hopper for storage of the chemical material, a gate valve disposed between the tank and hopper, a mixer to agitate and blend the chemical material with the water and form the chemical solution and a pump to aid in drawing the chemical solution out of the tank and toward a desired application. The system is configured to provide long-term storage of the chemical material in the hopper, while keeping the chemical material available for rapid delivery to the tank when needed.

### CROSS-REFERENCE TO RELATED APPLICATION

This application claims priority under 35 U.S. §119(e) from U.S. Ser. No. 61/547,399 filed Oct. 14, 2011. The disclosure of U.S. Ser. No. 61/547,399 is incorporated herein by reference in its entirety.

### FIELD OF THE INVENTION

This invention relates to water treatment, and more particularly to an apparatus and a method for introducing a chemical solution into a water stream at a high delivery rate and at a controlled concentration.

### BACKGROUND OF THE INVENTION

Water treatment is needed in a variety of applications. Untreated water provides a hospitable environment for the growth of bacteria, algae, and other undesirable and potentially unhealthy organisms. It has become common practice to treat water on a periodic or continuous basis by introducing chemicals to control such bacteria, algae, and organisms.

Chemical feeders have been developed to bring water into contact with solid, dry chemicals to dissolve the chemical material in the water in a controlled manner and to create a chemical solution that is then introduced into a water stream to treat a body of water. For example, when calcium hypochlorite is used to treat a body of water, chlorine is introduced into the water stream and the quantity of chlorine in the water generally expressed as a concentration of free available chlorine (FAC). In this instance, the feeder must be able to dissolve the calcium hypochlorite at a desired rate, so as to maintain a desired FAC concentration, while avoiding undesirable calcium carbonate deposits or residues.

In a typical application, such as public water supplies, cooling towers, and other industrial applications, chemical feeders for water treatment are able to provide a continuous supply of treated water where such a constant treatment of water must be assured. However, in emergency situations where a rapid delivery of a chemical solution is necessary, a typical chemical feeder application is inadequate. It is therefore desirable to implement a chemical feeder that can quickly and efficiently deliver a chemical solution in emergency situations to treat a body of water.

### SUMMARY OF THE INVENTION

The present invention relates generally to a rapid rate chemical solution generator system that can quickly and efficiently produce a chemical solution for an application that requires immediate attention. For example, the system may be advantageously used in cases of a disruption of a municipal water supply, sewer overflow, in cooling towers, and in other industrial applications that require delivery of a chemical solution at a rapid rate in a short period of time. Generally, the system includes a tank for mixing chemical material with water, a hopper for storage of the chemical, and a mixer to formulate the chemical solution. The system is configured to provide long-term storage of the chemical material while being ready for rapid delivery of the chemical material to the tank when needed. In operation, the chemical material can be loaded into the tank either manually or automatically via a hopper. The chemical material is then rigorously agitated using the mixer to disperse the chemical and create a solution to treat a body of water. The system may also include a programmable logic controller and load cells to control the delivery rate and concentration of the solution.

Broadly, the present invention relates to a method for preparing a chemical solution via a rapid rate chemical solution generator system, which includes a hopper, a tank located below the hopper, a supply valve disposed between the hopper and the tank, a mixer extending into the tank, and a pump connected to the tank. The method comprises the steps of placing a dry chemical, such as briquettes or granules, in the hopper, activating a first signal to indicate that a chemical solution is required for water treatment, filling the tank with fluid in response to the first signal to a predetermined upper level, subsequently turning the mixer on and concurrently opening the chemical supply valve to allow at least a portion of the dry chemical to drop into the tank, shearing and mixing the dry chemical with the fluid to produce a chemical solution, then activating the pump to remove the chemical solution from the tank so that the chemical solution can be dispersed into a body of water that requires treatment, thereby lowering the level of the fluid in the tank to a predetermined lower level. The dry chemical used in the method can be, for example, calcium hypochlorite, and the strength of the chemical solution can be adapted to be in the range of 0.5% available chlorine to 15% available chlorine. Moreover, the hopper can be configured to store the dry chemical for at least one day, and when the dry chemical is admitted to the tank it can be at a rate in the range of about 1 lb. per day to about 700 lb. per day.

The method can also include a second signal that is generated once the level of the fluid in the tank is at or below the predetermined lower level. In response to a second signal, the tank is refilled with the fluid and the hopper is refilled with the dry chemical.

Additionally, the solution generator system can be adapted to further include an inlet valve and a control unit that is connected to the chemical supply valve and the inlet valve. Here, the control unit is configured to receive the first signal and the second signal. Moreover, the control unit is configured to control a strength of the chemical solution by adjusting the supply valve to control a feed rate of the dry chemical to the tank and the inlet valve to control the amount of fluid entering the tank.

The method can further include a step where the control unit receives a remotely generated signal that indicates the strength of the chemical solution to be prepared.

Yet another possible method step can include flushing the tank to drain and rinse the tank and the pump prior to refilling the tank with fluid and the dry chemical.

Additionally, the present invention relates to a system for preparing a chemical solution, which comprises a tank, a hopper mounted above the tank, a supply valve disposed between the hopper and the tank, a mixer, which is mounted to the tank and is partially disposed in the tank, and a pump connected to the tank to draw the chemical solution out of the tank. The hopper, which can be made of plastic, is configured to store a chemical, which can be a dry chemical, for at least six months. The supply valve can be a knife-gate valve. The mixer can be mounted to the tank at an angle to aid in agitating and blending the chemical with water to produce the chemical solution.

The system can also include a discharge valve that is mounted to a sidewall of the tank to allow the chemical solution to exit the tank. Moreover, the system can include a discharge line that extends from the discharge valve and a pump inlet line that extends from the discharge line to the pump. Furthermore, the system can include two pumps, a first pump and a second pump, that are connected to the tank. In this instance, the system could also include a first pump inlet line that extends from the discharge line to the first pump and a second pump inlet line that extends from the discharge line to the second pump.

Additionally, the system can include a monitor device for monitoring a level of fluid in the tank, a pump control device for controlling activation of the pump, a water inlet control device for controlling inlet of water to the tank, a mixer control device for controlling the mixer between an on state and an off state, and a valve control device for controlling the supply valve between an open state and a closed state. The water inlet control device is configured to cause the tank to fill with water to a predetermined upper level in response to a first signal. The mixer control device is configured to cause the mixer, in a first state, to turn on subsequent to the fluid level attaining the predetermined upper level and, in a second state, to turn off once the fluid level reaches a predetermined lower level. The valve control device is configured to cause the supply valve to open concurrently with the mixer being turned on, thereby causing the dry chemical to enter the tank. The pump control device is configured to activate the pump to remove the chemical solution from the tank with the pump remaining activated while the level of fluid in the tank is at or above the predetermined lower level, so that the system is configured for automated standby operation.

The system can further include an alarm and a diagnostic device configurable by a system user, and at least one of a programmable human-machine interface and a programmable logic controller Those skilled in the art should appreciate that they can readily use the disclosed invention and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

The present invention will be further understood and appreciated by reading the following description in conjunction with the accompanying drawing, in which:

FIG. 1 is a perspective view of a rapid-rate chemical solution generator system in accordance with an embodiment of the invention;

FIG. 2 is a first side view of the system of FIG. 1;

FIG. 3 is a second side view of the system of FIG. 1, showing a pump, a hopper unit, and a chemical solution preparation unit of the system;

FIG. 4 is a partially exploded view of the system of FIG. 1;

FIG. 5 is perspective view of a mixing head of the system; and

FIG. 6 is a flowchart showing a method for generating a water treatment solution.

### DETAILED DESCRIPTION OF THE INVENTION

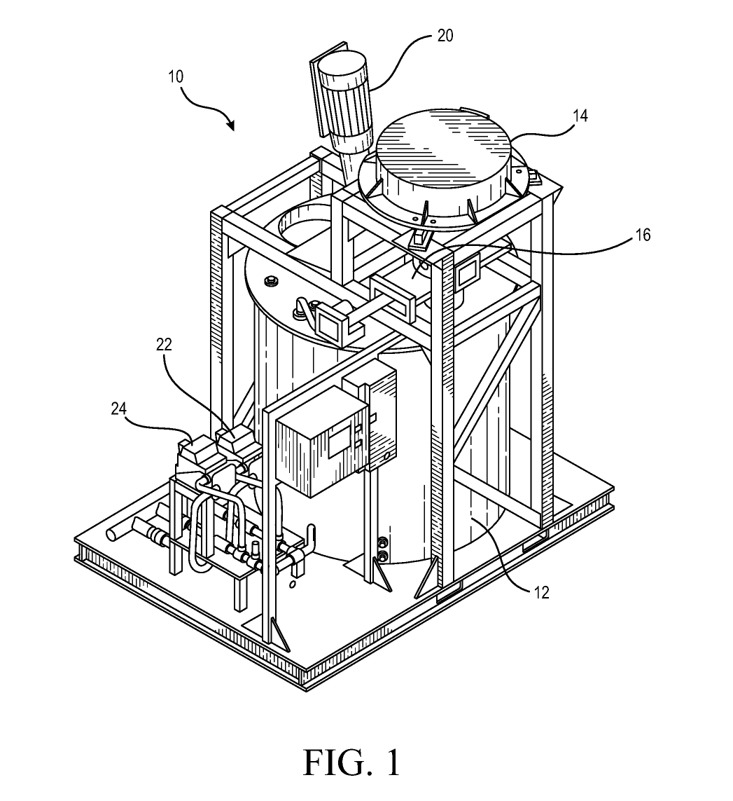

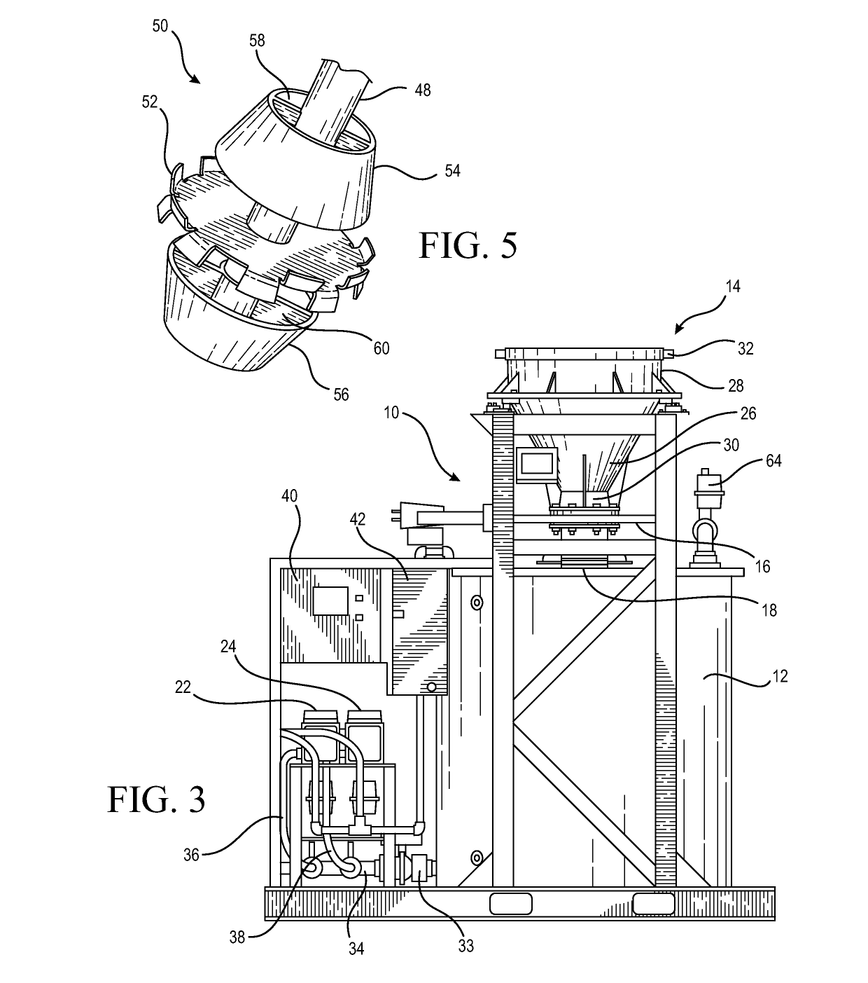

FIG. 1 illustrates a system 10 for rapid-rate generation of a water treatment solution, in accordance with an embodiment of the invention. The system 10 includes a mixing tank 12 and a hopper 14, which is mounted on the top of the mixing tank 12 for storing chemicals, such as calcium hypochlorite and a water inlet valve 64, which allows water to enter tank 12. The chemicals may be in the form of granules, briquettes, or any other shape that may be efficiently refined and blended with water in the tank 12. A gate valve 16 is disposed between a lower end of the hopper 14 and an opening 18 (See FIG. 3) in the top of the tank 12. The system 10 also includes a mixer/homogenizer unit 20 that is mounted to the top of the tank 12 and extends downward into the tank 12. Furthermore, the system 10 includes dosing pumps 22, 24, which pump a chemical solution that is formed in the tank 12 from the tank 12 to an output line (not shown) that leads to the water stream requiring treatment. Although two dosing pumps 22, 24 are shown in this embodiment, the number of dosing pumps can vary depending on the application.

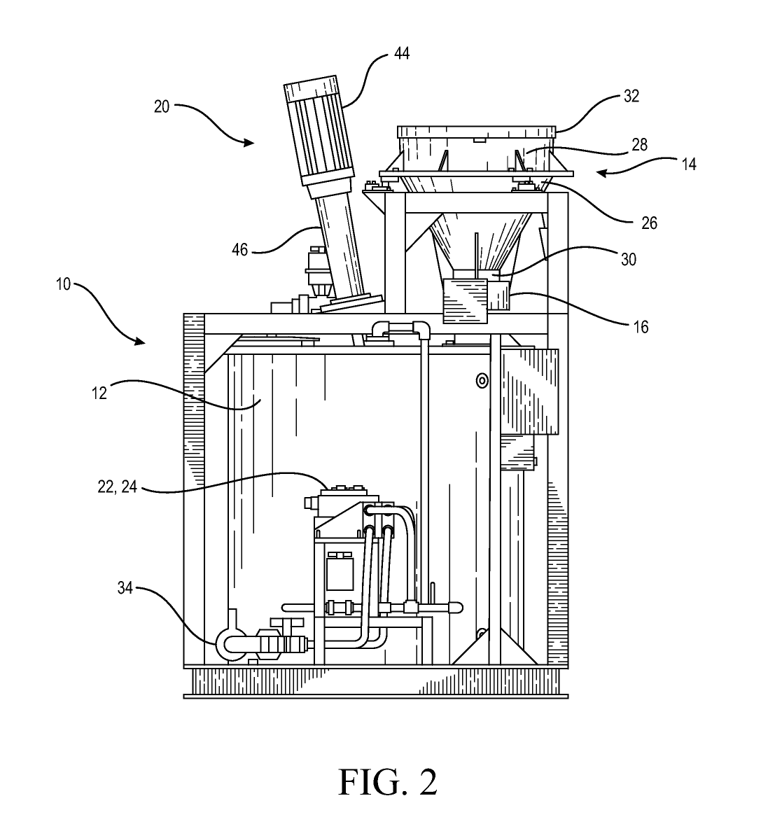

FIG. 2 is a first side view of the system 10, which shows the hopper 12 and the mixer/homogenizer unit 20 mounted on top of the tank 12. The hopper 14 has a body 26 with generally an inverted frusto-conical shape such that the body 26 has a wider upper opening and a narrower lower opening. The body 26 also has a first cylindrical portion 28 that extends from the upper end of the frusto-conical portion of the body 26 and a second cylindrical portion 30 that extends from the lower end of the frusto-conical portion of the body 26. A lid 32 covers the first cylindrical portion 26 and the second cylindrical portion 30 is connected to the gate valve 16, which is normally closed. Hence, the chemical material is protected from the environment since the body 26 of the hopper 12 is sealed at both ends. The hopper 14 is configured to provide long-term storage of the chemical material, while keeping it available for rapid delivery to the tank 12 when needed. In this embodiment, the hopper body 26 and the hopper lid 32, which does not provide an airtight covering, are made of plastic for safe storage of chemical material. Alternatively, the hopper body 26 and the lid 32 can be made of any other known material that is suitable for storage of chemicals that can be used in the system 10, and the lid 32 can be airtight.

FIG. 3 is second side view of the system, showing the hopper body 26 connected to the gate valve 16, which controls access to the tank 12 via the opening 18 in the top of the tank 12. In the embodiment shown herein, the gate valve 16 is a “knife-gate” type valve, in which a flat cover, when activated either manually or remotely, moves horizontally to open and close the valve 16. When the gate valve 16 is open, this allows access into the tank 12 and permits the chemical material to fall from the hopper 14 into the tank 12. Once the chemical is refined and mixed with the water and the desired solution concentration is reached, a discharge valve 33 is opened and the solution is then drawn out of the tank 12 via a discharge line 34 that is connected to and extends from the side wall of the tank 12, near the bottom thereof. Two pump inlet lines 36, 38 branch from the discharge line 34 and lead to the two dosing pumps 22, 24, respectively. From the dosing pumps 22, 24, the chemical solution travels through the output line to a water source requiring treatment.

To ensure proper operation of the system 10, control/monitor units/devices 40, 42 control the operation of the water inlet 64, which is controlled via a water inlet control device (not shown), the pumps 22, 24, via a pump control device (not shown), the gate valve 16, via a gate control valve (not shown), and the mixer/homogenizer unit 20 via a mixer control device (not shown). The control/monitor units/devices 40, 42 also receives an input from a monitor device (not shown) for monitoring the level of fluid in the tank 12. Each of the water inlet control device, the pump control device, the gate valve control device, mixer control device may be conventional devices known to those skilled in the art such as solenoids, load cells and the like. The device for monitoring the level in the tank may be any suitable monitoring devices such as a float in the tank, a pressure sensor which measures the pressure generated by the hydraulic head in the tank, and the like. Each of these devices may be connected to the control/monitoring units 40, 42 via a wiring (not shown) or wirelessly (not shown), using known techniques. It will be appreciated that the system 10 is capable of automated operation, where a chemical solution is delivered to a point of application in response to an external signal, without operator intervention. Additionally, the system 10 can include a programmable human-machine interface and/or a programmable logic controller, which may be located in control/monitor units 40, 42, or may be a portable device, such as a laptop computer, smartphone, tablet computer, or other similar device which can be plugged into the control/monitor units 40, 42 via a connector, such as a USB connection. The control/monitoring units 40, 42 may also have an alarm (not shown) and/or a diagnostic device (not shown) for diagnosing any problems or issues with the system.

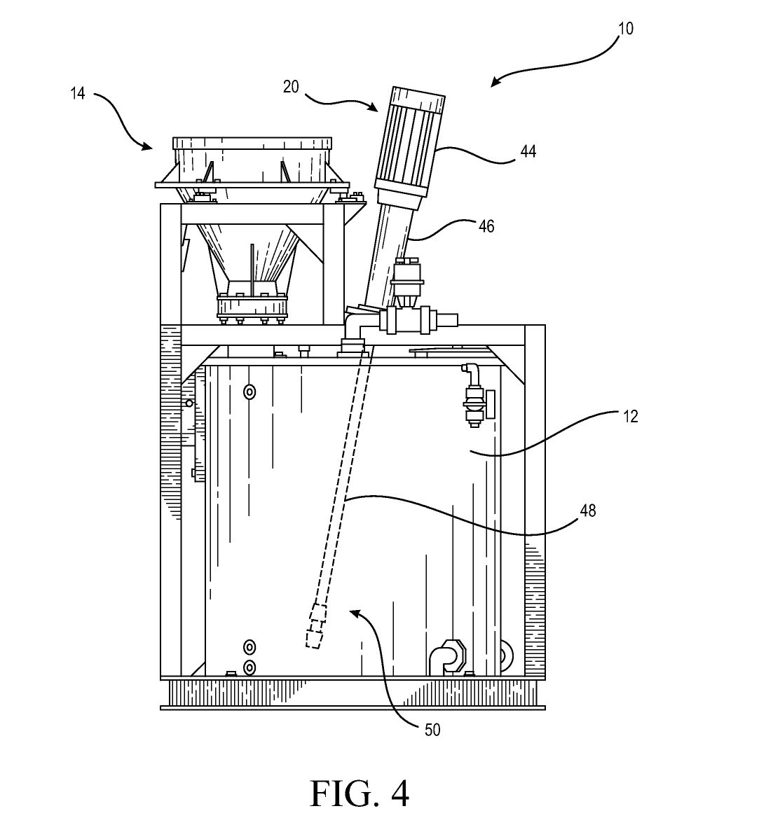

FIG. 4 is a partially exploded view of the system 10, showing the mixer/homogenizer unit 20 extending into the interior of tank 12. The mixer/homogenizer unit 20 includes a driver unit 44, a shaft housing 46, a shaft 48 that extends at one end from shaft housing 46 into the tank 12, and a mixer head 50 that is attached to the other end of shaft 48. In use, the mixer/homogenizer unit 20 rigorously agitates the chemicals in the tank 12 to micro-disperse and blend the chemicals with water to create a water treatment solution. As shown, the mixer/homogenizer unit 20 is angled with respect to the tank 12 to provide more efficient agitation and mixing of the solution within the tank 12. It should be noted that the mixer/homogenizer unit 20 shown herein is manufactured by Scott Turbon Mixer, Inc.: however, any other known mixer/homogenizer can be used in place of the mixer/homogenizer unit 20 that is shown herein.

FIG. 5 is a detail view showing the mixer head 50. The mixer head 50 has a toothed wheel 52 that is arranged between two cone-shaped components 54, 56, which each have openings 58, 60 therein. The openings 58, 60 create a venturi effect to draw the chemical material toward the toothed wheel 52 for efficient shearing and mixing with water. This mixer head 50 is generally known as a shearing-type mixer, which is capable of shearing and chopping solids in either granular or brick form. In operation, granular solids that are introduced into water in the tank 12 are sheared, refined, and incorporated into the water. Alternatively, solids in brick form are first suspended and then pulled through a shear zone, proximate to the mixer head 50, to be chopped.

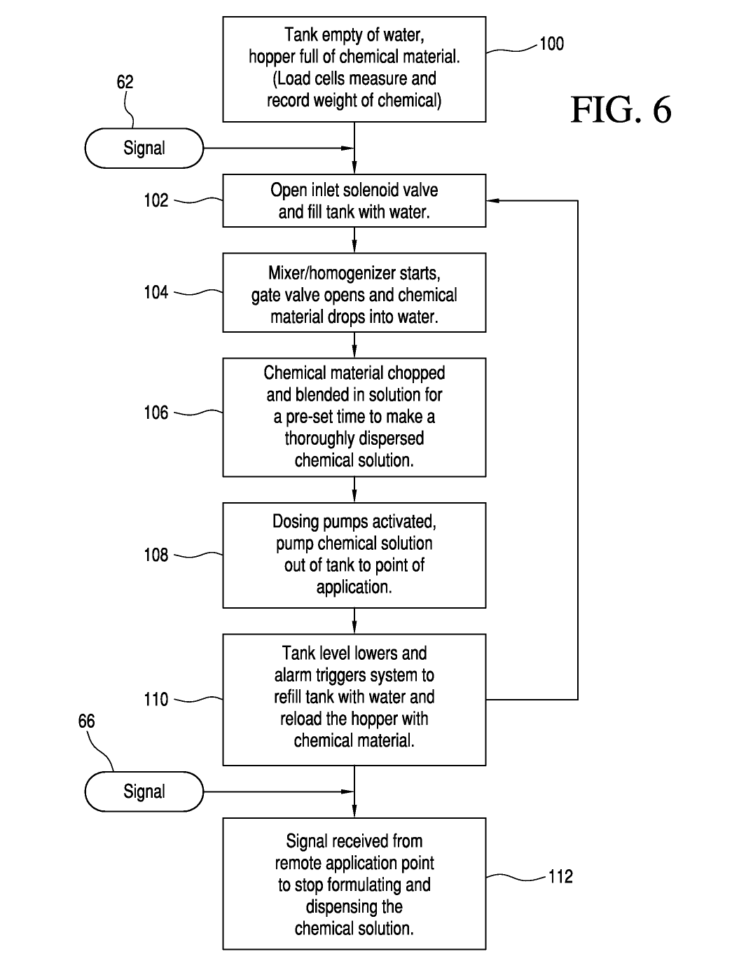

FIG. 6 illustrates an automated process for generating the water treatment solution. Initially, the system is in a standby mode (Step 100). In the standby mode, the tank 12 is empty and the hopper 14 is full of the chemical material. Load cells are used to measure and record the weight of the chemical material in the hopper 12. The system 10 can remain in standby mode without being activated for an extended period of time (e.g., up to 1 year). During this time, the gate valve 16 remains closed and the chemical material remains stored in the hopper 14. When the system 10 receives a first signal 62 that a water treatment solution is required, the inlet valve 64 for the supply water is opened. This causes the tank 12 to fill with water (Step 102). Then, when the water level in the tank 12 reaches a predetermined upper level, the mixer/homogenizer unit 20 is turned on and the gate valve 16 opens to allow the chemical material (e.g., granules or briquettes) to drop into the tank 12 that has been filled with water (Step 104). It is noted that the predetermined upper level may vary depending on the desired concentration of the chemical solution. For example, if the more concentrated solution is desired, the predetermined upper level will be lower that if a lower concentration of the chemical solution is desired. Alternatively, the predetermined upper level may be a set level in the tank and the amount of the dry chemical added to the tank can be varied to control the concentration of the chemical solution. The level in tank 12 can be determined using any conventional monitor device (not shown) to monitor the level of the fluid in the tanks Suitable monitoring devices include means, such as a float in the tank, a pressure sensor which measures the pressure generated by the hydraulic head in the tank, and the like. The mixer/homogenizer unit 20 then chops and blends the chemical material for a pre-set time (e.g., up to 5 minutes) to produce a thoroughly dispersed solution of chemical material (Step 106). After this cycle is complete, the dosing pumps 22, 24 are activated to pump the chemical solution out of the tank 12 and to the point of application where disinfection of the water is needed (Step 108). As the water-based chemical solution is pumped out of the tank 12, the tank 12 reaches a pre-set lower level. The pre-set lower level can be when the tank is empty, or a level that is generally below the top of the mixing mixer head 50 in tank 12. At this point, an alarm triggers the system 10 to re-fill the tank 12 with water and re-load the chemical material in the hopper 14 (Step 110). The cycle of Steps 102-110 then repeats. The process continues until a remote application point sends a second signal 66 to stop feeding the water treatment solution to the point of application (Step 112). Once the process is complete, the system 10 is returned to its initial standby condition where the hopper 14 is again filled with chemical material and the tank 12 is emptied of solution.

Depending on the application of the chemical solution, the strength of the solution can be customized by varying the rate at which the chemical material is allowed to fall into the tank 12, which can be, for example, 1 lb/day to 700 lbs/day. Also, in the case of calcium hypochlorite, the solution strength can roughly be in the range of 0.5% to 15% of FAC. To aid in controlling the feed rate of the chemical from the hopper 14 to the tank 12 and the concentration of the solution, the system has a programmable logic controller and load cells are used. In the embodiment described herein, the system 10 is fully automated and is activated by the first signal 62 and the second signal 66 from a remote application point, without operator intervention. The chemical material can be added to the hopper during the process, either manually or automatically. Moreover, the system 10 may be operated as a “single charge” system, where the entire contents of the hopper 14 are emptied into the tank 12 so that a concentrated water treatment solution can then be delivered in a few minutes.

While the invention has been described in terms of a specific embodiment, it is evident in view of the foregoing description that numerous alternatives, modifications, and variations will be apparent to those skilled in the art. Accordingly, the invention is intended to encompass all such alternatives, modifications, and variations which fall within the scope and spirit of the invention and the following claims.

What is claimed:

1. A method for preparing a chemical solution via a rapid rate chemical solution generator system, which includes a hopper, a tank located below the hopper, a supply valve disposed between the hopper and the tank, a mixer extending into the tank, and a pump connected to the tank, the method comprising the steps of:
placing a dry chemical in the hopper;
activating a first signal indicating that a chemical solution is required for water treatment;
filling the tank with fluid in response to the first signal to a predetermined upper level;
subsequently turning the mixer on and concurrently opening the chemical supply valve to allow at least a portion of the dry chemical to drop into the tank;
shearing and mixing the dry chemical with the fluid to produce a chemical solution;
subsequently activating the pump to remove the chemical solution from the tank so that the chemical solution can be dispersed into a body of water that requires treatment, thereby lowering the level of the fluid in the tank to a predetermined lower level.

2. The method of claim 1, wherein a second signal is generated once the level of the fluid in the tank is at or below the predetermined lower level and, in response to the second signal, the tank is refilled with the fluid and the hopper is refilled with the dry.

3. The method according to claim 2, wherein the solution generator system is adapted to further include an inlet valve and a control unit that is connected to the chemical supply valve and the inlet valve, the control unit is configured to receive the first signal and the second signal, and the control unit is configured to control a strength of the chemical solution by adjusting the supply valve to control a feed rate of the dry chemical to the tank and the inlet valve to control the amount of fluid entering the tank.

4. The method according to claim 3, wherein the control unit receives a remotely generated signal, and the remotely generated signal indicates the strength of the chemical solution to be prepared.

5. The method according to claim 1, wherein the dry chemical is briquettes or granules.

6. The method according to claim 2, wherein the dry chemical is calcium hypochlorite, and the strength of the chemical solution is adapted to be in the range of 0.5% available chlorine to 15% available chlorine.

7. The method according to claim 1, wherein the hopper is adapted to store the dry chemical for at least one day, and the dry chemical is admitted to the tank at a rate in the range of about 1 lb per day to about 700 lb per day.

8. The method according to claim 1, wherein the tank is flushed to drain and rinse the tank and the pump prior to refilling the tank with fluid and the dry chemical.

9. A system for preparing a chemical solution, comprising:
a tank;
a hopper mounted above the tank, which is configured for storing a chemical;
a supply valve disposed between the hopper and the tank;
a mixer, which is mounted to the tank and is partially disposed in the tank, for mixing the chemical with water to produce the chemical solution; and
a pump connected to the tank to draw the chemical solution out of the tank.

10. The system according to claim 9, wherein the chemical is a dry chemical and the hopper is configured to store the dry chemical for at least six months.

11. The system according to claim 9, wherein the hopper is made of plastic.

12. The system according to claim 9, wherein the supply valve is a knife-gate valve.

13. The system according to claim 9, wherein the mixer is mounted to the tank at an angle to aid in mixing and agitation of the chemical solution.

14. The system according to claim 9, further comprising a discharge valve that is mounted to a sidewall of the tank to allow the chemical solution to exit the tank.

15. The system according to claim 14, further comprising a discharge line extending from the discharge valve and a pump inlet line extending from the discharge line to the pump.

16. The system according to claim 9, wherein there are two pumps, a first pump and a second pump, connected to the tank.

17. The system according to claim 16, further comprising a discharge line extending from the discharge valve, a first pump inlet line extending from the discharge line to the first pump, and a second pump inlet line extending from the discharge line to the second pump.

18. The system according to claim 9, further comprising:
a monitor device for monitoring a level of fluid in the tank;
a pump control device for controlling activation of the pump;
a water inlet control device for controlling inlet of water to the tank;
a mixer control device for controlling the mixer between an on state and an off state; and
a valve control device for controlling the supply valve between an open state and a closed state,
wherein the water inlet control device is configured to cause the tank to fill with water to a predetermined upper level in response to a first signal, the mixer control device is configured to cause the mixer, in a first state, to turn on subsequent to the fluid level attaining the predetermined upper level and, in a second state, to turn off once the fluid level reaches a predetermined lower level, the valve control device is configured to cause the supply valve to open concurrently with the mixer being turned on, thereby causing the dry chemical to enter the tank, the pump control device is configured to activate the pump to remove the chemical solution from the tank, the pump remaining activated while the level of fluid in the tank is at or above the predetermined lower level, so that the system is configured for automated standby operation.

19. The system according to claim 9, further comprising an alarm and a diagnostic device configurable by a system user.

20. The system according to claim 9, further comprising at least one of a programmable human-machine interface and a programmable logic controller.
